(19) United States
(12) Patent Application Publication
(10) Pub. No.: US 2006/0078055 A1
(43) Pub. Date: Apr. 13, 2006

(54) Signal processing apparatus and signal processing method

(76) Inventor: Sadayoshi Kanazawa, Osaka (JP)

Correspondence Address: RATNERPRESTIA, P.O. BOX 980, VALLEY FORGE, PA, 19482, US

(21) Appl. No.: 11/247,693

(22) Filed: Oct. 11, 2005

(30) Foreign Application Priority Data
Oct. 13, 2004 (JP) 2004-298700

(51) Int. Cl. H04B 1/66; G06K 9/40; H04N 11/02

(52) U.S. Cl. 375/240.27; 382/268

(57) ABSTRACT

A signal processing apparatus and signal processing method which can realize a noise reduction filter capable of displaying noise reduction effects of same levels with respect to images scaled to various sizes are provided. The signal processing apparatus and signal processing method select adjacent pixels when executing noise reduction filtering of images DCT coded by 8×8 pixel blocks, and in the case of images changed in block size scaled and DCT coded, pixel closer to the pixel of original image is selected, and thereby, it is possible to assure the width of filter without changing the number of pixels used for filters.

### FIELD OF THE INVENTION

The present invention relates to a signal processing apparatus using a noise reduction (NR=Noise Reduction) filter for reducing noise of image, and a signal processing method.

### BACKGROUND OF THE INVENTION

In products handling coded image signals such as a DVD recorder, some uses an NR filter for reducing black noise or mosquito noise.

(Configuration of Filter Unit 1300)

FIG. 13 is a block diagram describing filter unit 1300 for NR processing which is a signal processing apparatus. Filter unit 1300 is a signal processing apparatus.

Filter unit 1300 comprises horizontal NR processor 1301 whose input is decoded image signal 1303 and output is horizontal NR processing pixel signal 1304, and vertical NR processor 1302 whose input is horizontal NR processing pixel signal 1304 and output is NR processing signal 1305.

Horizontal NR processor 1301 is a section for executing horizontal NR processing of decoded image signal 1303, which comprises condition determining unit 1306 and horizontal NR process executing unit 1307. Condition determining unit 1306 determines whether or not a horizontal NR filter is applied to decoded image signal 1303 (also determining an applicable filter out of several filters in case of applying a filter) in accordance with horizontal NR determining threshold 1308 that has been set. Horizontal NR process executing unit 1307 executes horizontal NR processing of decoded image signal 1303 in accordance with decoded image signal 1303 and determination result 1309 of condition determining unit 1306, and outputs horizontal NR processing pixel signal 1304.

Vertical NR processor 1302 is a section for executing vertical NR processing of horizontal NR processing pixel signal 1304, which comprises condition determining unit 1310 and vertical NR process executing unit 1311. Condition determining unit 1310 determines whether or not a vertical NR filter is applied to horizontal NR processing signal 1304 (also determining an applicable filter out of several filters in case of applying a filter) in accordance with vertical NR determining threshold 1312 that has been set. Vertical NR process executing unit 1311 executes vertical NR processing of horizontal NR processing signal 1304 in accordance with horizontal NR processing signal 1304 and determination result 1313 of condition determining unit 1310, and outputs NR processing signal 1305.

The process executed in horizontal NR processor 1301 is described by using luminance Y signal 1400 in range of filter reference pixel (pixel refered to by a filter), differential absolute value calculation 1401 of filter reference adjacent pixels, and applicable filter determining condition 1402 in FIG. 14, and 7-tap coefficients 1500 for each filter and horizontal NR processing calculation formula 1501 in FIG. 15.

The case of horizontal NR processor 1301 using a 7-tap filter will be described. Condition determining unit 1306 determines from decoded pixel signal 1303 that the filter reference range includes 7 pixels, that is, a filtration pixel and 3 pixels each in front and rear of the filtration pixel. The 7 pixels in the filter reference range including the filtration pixel are represented by Luminance Y signal in filter reference range 1400 (suppose that the block boundary peculiar to coded image signal is between pixel n+2 and pixel n+3), and d [0] to d [5] of Differential absolute value calculation of filter reference adjacent pixels 1401 are calculated. By using d [0] to d [5] calculated in Differential absolute value calculation of filter reference adjacent pixels 1401 and horizontal NR determining threshold 1308, the applicable filter is determined by Applicable filter determining conditions 1402 (since the pixel for calculating d [5] in differential absolute value calculation 1401 of filter reference adjacent pixels has a block boundary there between, d [5] is compared with the threshold for block boundary) and (in applicable filter determining condition 1402, they are arranged from (1) in the order of priority), then determination result 1309 is delivered to horizontal NR process executing unit 1307. Horizontal NR process executing unit 1307, using 7-tap coefficients 1500 for each filter determined from determination result 1309 and luminance Y signal 1400 in range of filter reference pixel, calculates filtration pixel luminance signal Y′ [0] after horizontal NR process from horizontal NR calculation formula 1501. Filtration pixel luminance signal Y′ [0] is inputted to vertical NR processor 1302 as horizontal NR processing pixel signal 1304.

The basic operation of vertical NR processor 1302 is same as for that of horizontal NR processor 1301.

Items related to the above conventional technology are, for example, disclosed in ISO/IEC, 14496-2:2001 (E), “Information technology—Coding of audio-visual objects—Part 2:Visual”, Second edition, 2001.12.01, P.448-450.

### SUMMARY OF THE INVENTION

A signal processing apparatus, comprising:

a plurality of filters;

a determining unit for determining pixels referred to by the filters; and

a selecting means for selecting one out of the plurality of filters in accordance with image feature value calculated by using pixels selected by the determining unit and thresholds of image feature value set with respect to each of the plurality of filters.

A signal processing method, comprising:

a determining step for determining pixels referred to by a plurality of filters; and

a selecting step for selecting one out of the plurality of filters in accordance with threshold values of image feature value calculated by using pixels selected in the determining step and image feature value set with respect to each of the plurality of filters.

### BRIEF DESCRIPTION OF THE DRAWINGS

FIG. 1 is a block diagram describing filter unit 100 in the preferred embodiment 1 of the present invention.

FIG. 2 is a flow chart describing a filtering method in the preferred embodiment 1 of the present invention.

FIG. 3 is a schematic diagram describing the selection of pixels referred and an example of selection in the preferred embodiment 1 of the present invention.

FIG. 4 is a schematic diagram describing the calculation of image feature value and an applicable filter determining method in the preferred embodiment 1 of the present invention.

FIG. 5 is a schematic diagram describing the calculation of filtration in the preferred embodiment 1 of the present invention.

FIG. 6 is a flow chart describing a method of selecting pixels referred in the preferred embodiment 1 of the present invention.

FIG. 7 is a schematic diagram describing a method of selecting pixels referred in the preferred embodiment 1 of the present invention.

FIG. 8 is a schematic diagram describing a method of selecting pixels referred in the preferred embodiment 1 of the present invention.

FIG. 9 is a schematic diagram describing a method of selecting pixels referred in the preferred embodiment 1 of the present invention.

FIG. 10 is a schematic diagram describing a method of selecting pixels referred in the preferred embodiment 1 of the present invention.

FIG. 11 is a flow chart (preferred embodiment 2) describing a method of filtration in the preferred embodiment 2 of the present invention.

FIG. 12 is a schematic diagram describing an example of selecting referred pixels in the preferred embodiment 2 of the present invention.

FIG. 13 is a block diagram describing filter unit 1300 in conventional technology.

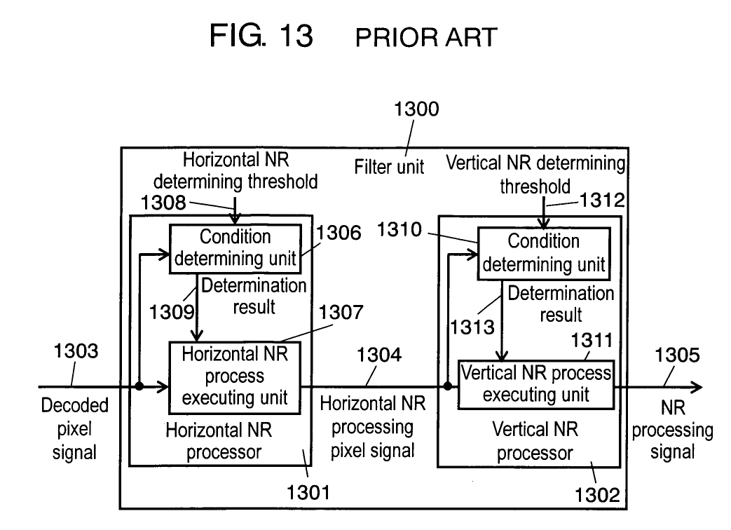

FIG. 14 is a schematic diagram describing an applicable filter determining method in conventional technology.

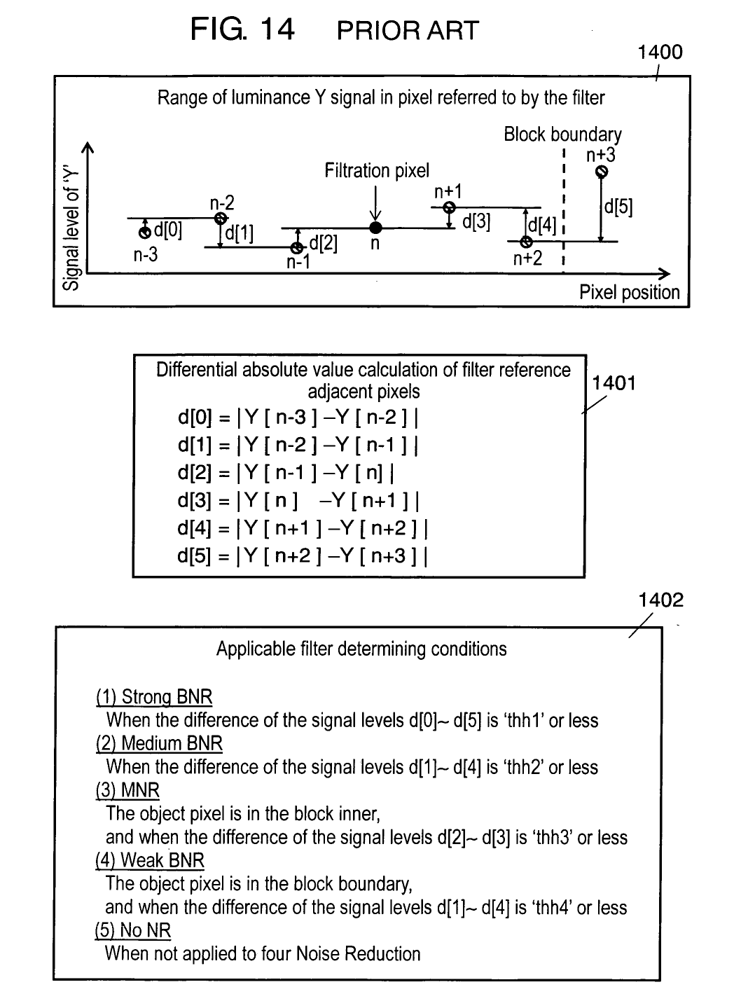

FIG. 15 is a schematic diagram describing the calculation of filtration in conventional technology.

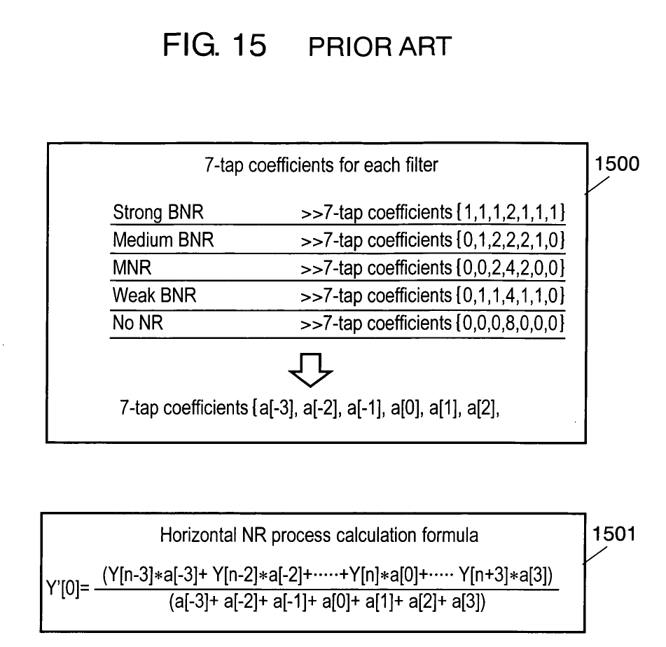

### DETAILED DESCRIPTION OF THE EXEMPLARY EMBODIMENTS

In a conventional filter unit (signal processing apparatus) described above, NR processing is executed by using adjacent filter reference pixels. The filter reference pixels are pixels referred to by a filter. Accordingly, when a similar NR filter is used for an image changed in block size of DCT (Discrete Cosine Transform) coding as a result of scaling of an image subjected to filtering, the number of pixels referred to remains unchanged but the resolution of the image to be filtered is enhanced, and therefore, the filter range becomes narrower as compared with the case of NR filtering of original image.

Also, since NR processing is executed by using adjacent filter reference pixels, only filters less than the filter reference range (only in a range less than 5 pixels when the number of taps is 5) that is limited by the hard configuration of the filter unit are applicable.

In the present invention, filter reference pixels can be optionally determined, and it is possible to freely arrange the filter reference pixels either discretely or continuously.

That is, when NR filtering is executed on image not scaled, adjacent pixels are selected, and in case of image scaled and changed in block size of DCT coding, pixels positioned closer to pixels scaled are selected, and thereby, it is possible to assure the filter width without changing the number of pixels used for the filter.

Also, even in case the number of taps of the filtering section is fixed, it is possible to freely select the arrangement although the number of filter reference pixels is limited.

In the signal processing apparatus (filter unit) of the present invention, the filter reference pixels can be optionally determined, and therefore, it is possible to realize an NR filter which may display noise reduction effects of similar levels with respect to images scaled to various sizes.

Also, for obtaining the above effects by using a conventional method, there arises a problem such as increase in circuit scale and complication of the process in proportion to the filter reference range. On the other hand, in the signal processing method of the present invention, it is possible to cope with all sizes without circuit change and with same algorithm.

The signal processing apparatus and signal processing method of the present invention will be described in the following with reference to the preferred embodiments. In the following description, filter unit 100 is an example of signal processing apparatus in the application concerned, and the signal processing method by the filter is an example of signal processing method in the application concerned.

### Preferred Embodiment 1

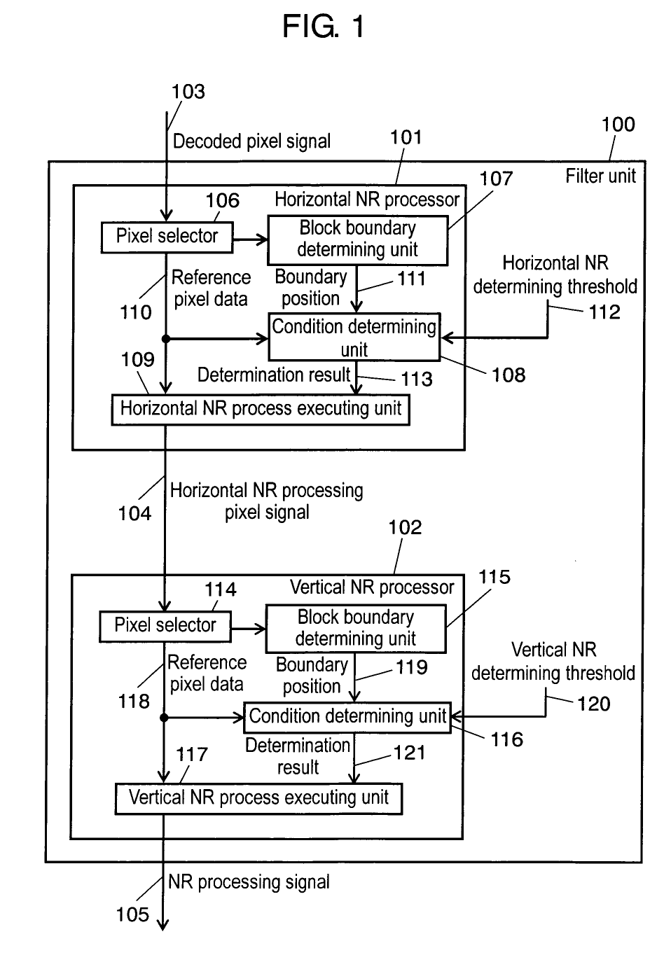

FIG. 1 shows a block diagram describing filter unit 100 for NR processing. The filter unit 100 is an example of signal processing apparatus in the application concerned.

[Configuration of Filter Unit 100]

Filter unit 100 comprises horizontal NR processor 101 whose input is decoded image signal 103 and output is horizontal NR processing pixel signal 104, and vertical NR processor 102 whose input is horizontal NR processing pixel signal 104 and output is NR processing signal 105.

Horizontal NR processor 101 is a section for executing horizontal NR processing of decoded image signal 103, which comprises pixel selector 106, block boundary determining unit 107, condition determining unit 108, and horizontal NR process executing unit 109. Pixel selector 106 selects a filter reference pixel, using decoded image signal 103 as input, and outputs reference pixel data 110. The filter reference pixel is pixel refered to by the filter. Block boundary determining unit 107 determines a block boundary position, using reference pixel data 110, and outputs boundary position 111. Condition determining unit 108 uses reference pixel data 110 as the first input, boundary position 111 as the second input, and horizontal NR determining threshold 112 as the third input. Condition determining unit 108 determines whether or not a horizontal NR filter is applied to reference pixel data 110 of the filter selected from decoded image signal 103 (also determining an applicable filter out of several filters in case of applying a filter) in accordance with each of the first input, the second input, and the third input, and outputs determination result 113. Horizontal NR process executing unit 109 executes horizontal NR process in accordance with reference pixel data 110 of the filter selected from decoded image signal 103 and determination result 113 of condition determining unit 108, and outputs horizontal NR processing pixel signal 104.

Vertical NR processor 102 is a section for executing vertical NR processing of horizontal NR processing pixel signal 104, which comprises pixel selector 114, block boundary determining unit 115, condition determining unit 116, and vertical NR process executing unit 117. Pixel selector 114 selects filter reference pixels, using horizontal NR processing pixel signal 104 as input, and outputs reference pixel data 118. Block boundary determining unit 115 determines a block boundary position, using reference pixel data 118 as input, and outputs boundary position 119. Condition determining unit 116 uses reference pixel data 118 as the first input, boundary position 119 as the second input, and vertical NR determining threshold 120 as the third input. Condition determining unit 116 determines whether or not a vertical NR filter is applied to reference pixel data 118 of the filter selected from horizontal NR processing pixel signal 104 (also determining an applicable filter out of several filters in case of applying a filter) in accordance with each of the first input, the second input, and the third input, and outputs determination result 121. Vertical NR process executing unit 117 executes vertical NR process in accordance with reference pixel data 118 of the filter selected from horizontal NR processing pixel signal 104 and determination result 121 of condition determining unit 116, and outputs NR processing signal 105.

[Operation of Filter Unit 100]

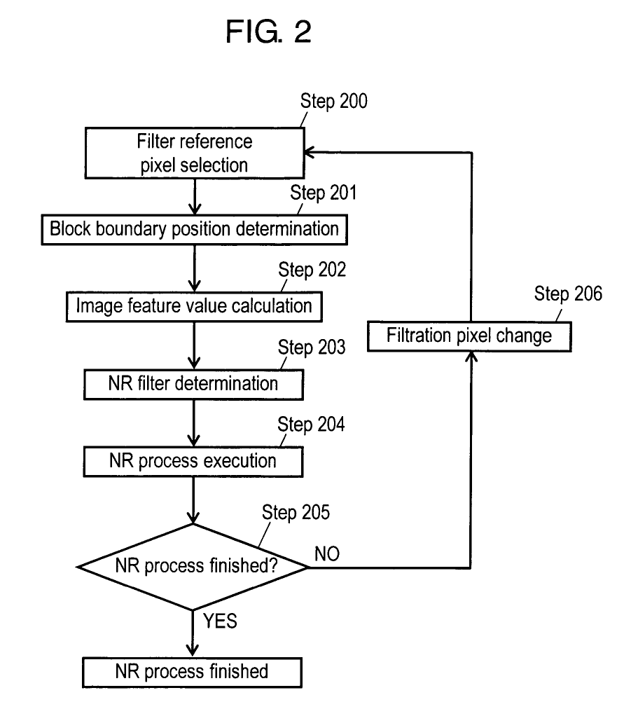

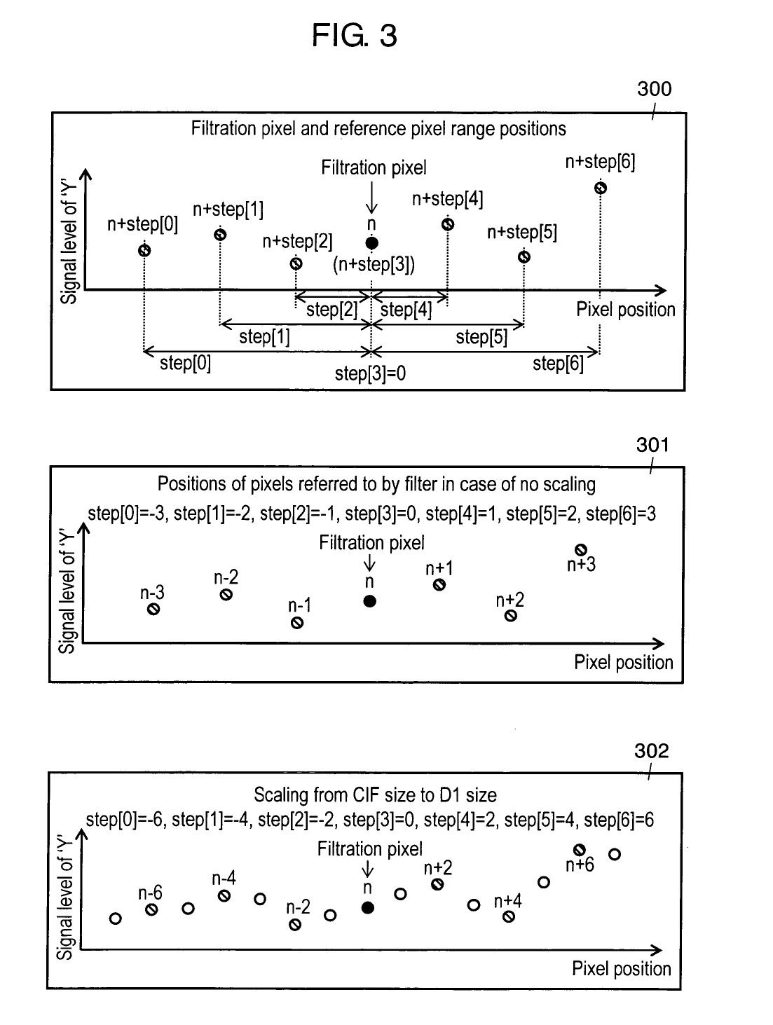

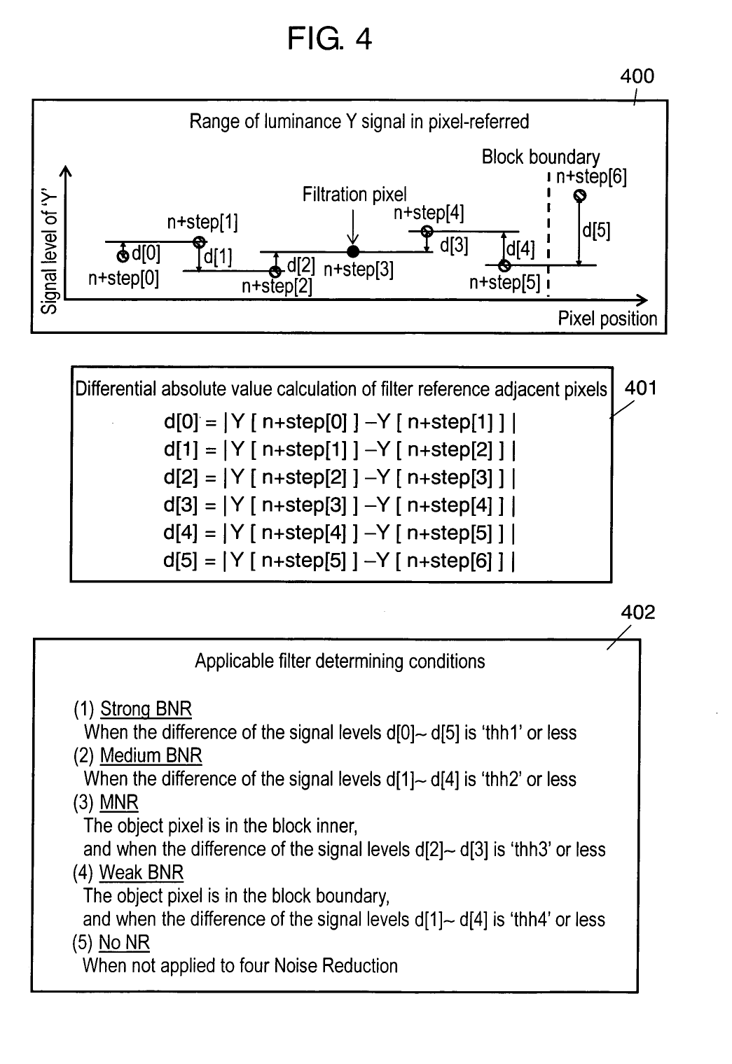

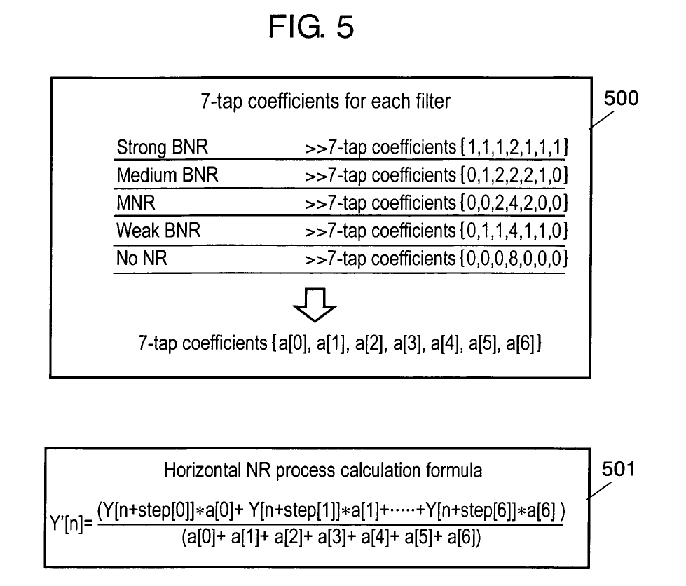

The operation of filter unit 100 will be described with reference to FIG. 2, FIG. 3, FIG. 4, and FIG. 5. FIG. 2 is a flow chart showing the NR processing method of the filter unit in the preferred embodiment 1. As an example, described here is a case such that filtration pixel n is subjected to NR filtering of 7 taps max.

In step 200 shown in FIG. 2, filter reference pixels concerned are determined in filtering of filtration pixel. The filter reference pixels are pixels referred to by the filter. Filter reference pixels are selected as shown in Filtration pixel and reference pixel positions 300 in FIG. 3. In case the distance from filtration pixel n ranges from step [0] to step [6], the filter reference pixels are determined to be 7 pixels ranging from n+step [0] to n+step [6]. (The method of selecting the filter reference pixels is described in detail later.) When NR processing is executed without scaling of the original image, adjacent 3 pixels in front and rear of the filtration pixel are filter reference pixels, and therefore, the value ranging from step [0] to step [6] is determined as in Filter reference pixel position without scaling 301 in FIG. 3. As an example of executing NR processing of image after scaling, filter reference pixels are shown in 302 of FIG. 3 where the original image is scaled from CIF (H360×V240) size to D1 (H720×V480) size. In the case of scaling from CIF to D1, the size becomes two times larger, and therefore, filter reference pixels are alternately selected as shown. In the preferred embodiment 1, the filter reference pixel selection in step 200 is executed each time the filtration pixel is changed.

In step 201, the determination of block boundary position is executed in two-dimensional DCT (Discrete Cosine Transform) of 8 pixels×8 pixels block used in encoding of MPEG (Moving Picture Experts Group) and JPEG (Joint Photographic Experts Group). (Since the DCT block size is generally fixed at 8 pixels, the block boundary also becomes periodic every 8 pixels. However, in case the original image is scaled, the block size is also changed, and the block boundary position is changed at same ratio as that of scaling.) When the block boundary exists in the range of filter reference pixels selected in step 200, the position of filter reference pixel where the block boundary exists (the position between the pixels ranging from n+step [0] to n+step [6]) is determined.

In step 202, because of the comparison with the threshold of image feature value set in each of the filters for determining the NR filter in step 203, the image feature value is calculated from filtration pixel. In FIG. 4, image feature values d [0] to d[5] for comparison with threshold are shown in Luminance Y signal in filter reference pixel range 400, and the calculation formulas of image feature values d [0] to d [5] are shown in Differential absolute value calculation of filter reference adjacent pixels 401.

In step 203, in accordance with the position of filter reference pixel where the block boundary obtained in step 201 exists and image feature values d [0] to d [5] obtained in step 202, comparison is made with the threshold of image feature value set in each of the filters for determining the NR filter, and the filter applied in step 204 is determined. As an example, applicable filter determining conditions 402 is shown in FIG. 4. In applicable filter determining conditions 402, the conditions are arranged from (1) in the order of priority, when the conditions for each filter mentioned are satisfied, the filter is applied. Thresholds thh1 to thh5 are set for the purpose of comparison with image feature values d [0] to d [5] in each condition, but as to the image feature values calculated between filter reference pixels across the block boundary position, the comparison is made with threshold thh_block for block boundary. For example, a block boundary is shown in Luminance Y signal in filter reference pixel range 400 in FIG. 4, but when the block boundary exists between reference pixel n+step [5] and reference pixel n+step [6], threshold thh_block for block boundary is applied with respect to image feature value d [5] calculated from reference pixel n+step [5] and reference pixel n+step [6].

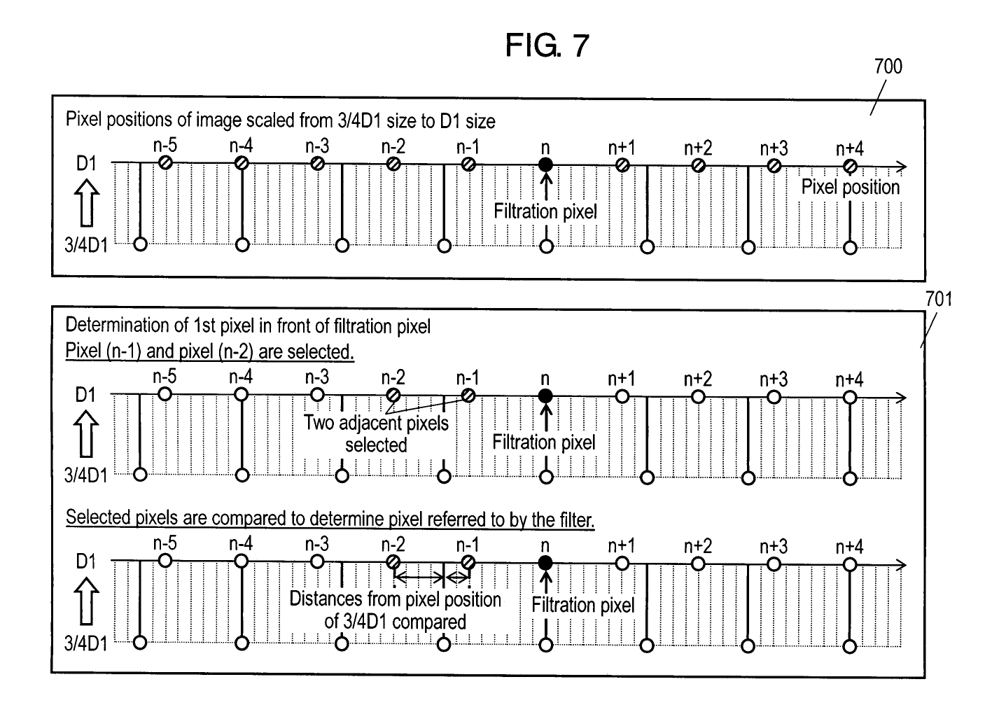

In step 204, in accordance with the filter reference pixel selected in step 200 with respect to filtration pixel n, NR processing is executed by the filter selected in step 203. In the calculation for NR processing, filtration pixel luminance signal Y′ [n] after NR processing is calculated by horizontal NR processing calculation formula 501 of FIG. 5, using luminance level Y [n+step [0]] to Y [n+step [6]] shown in Luminance Y signal level in filter reference pixel range 400 in FIG. 4 and 7-tap filter coefficients a[0] to a[6] corresponding to the filter selected in step 203 as shown in 7-tap coefficients of various filters 500 in FIG. 5.

In step 205, whether the NR processing is continued or finished is determined. When the NR processing is continued, it goes to step 206.

In step 206, the filtration pixel is changed. In the earlier NR processing, the NR processing is executed with respect to pixel n, and then, as the next pixel n+1 is the filtration pixel, it goes to step 200. Further, from step 200, filter reference pixel is selected from filtration pixel n+1, and similar processing will be executed.

[Filter Reference Pixel Selecting Method]

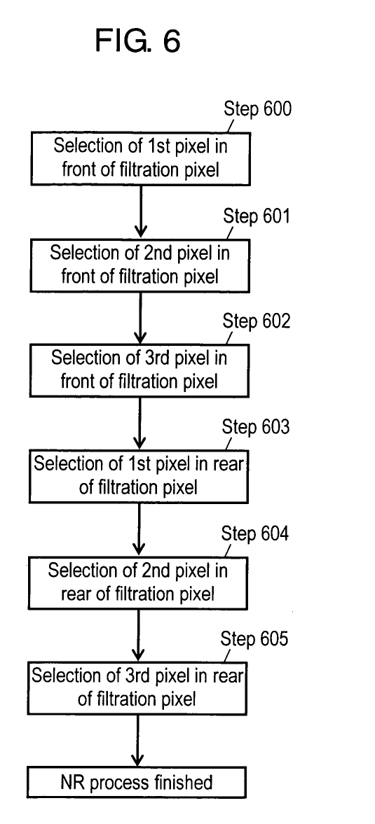

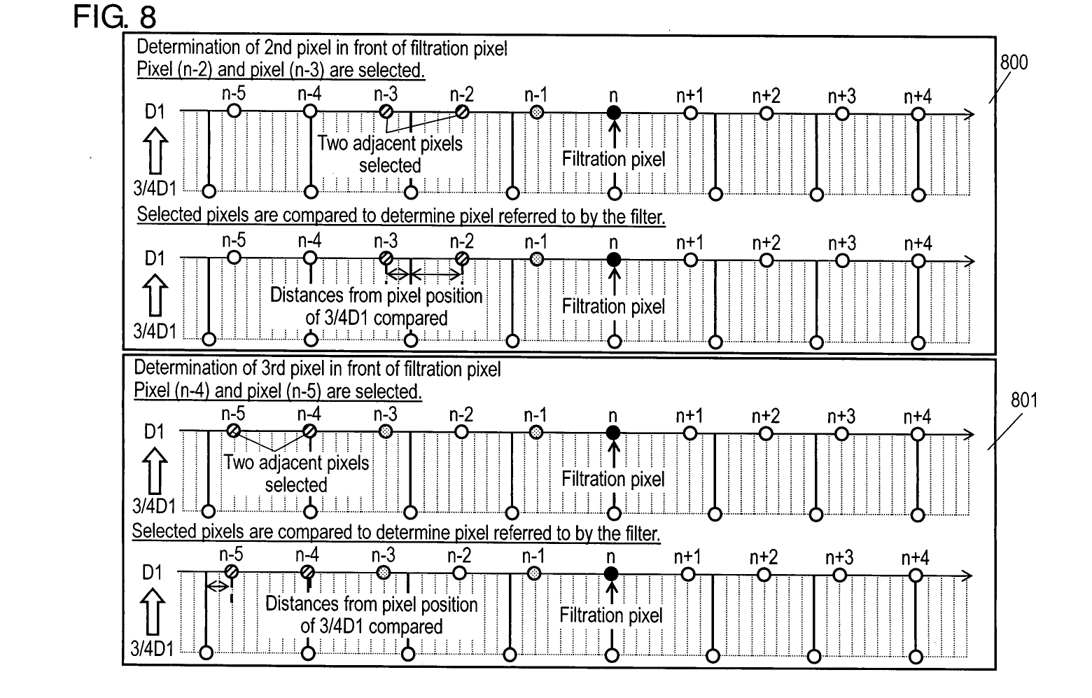

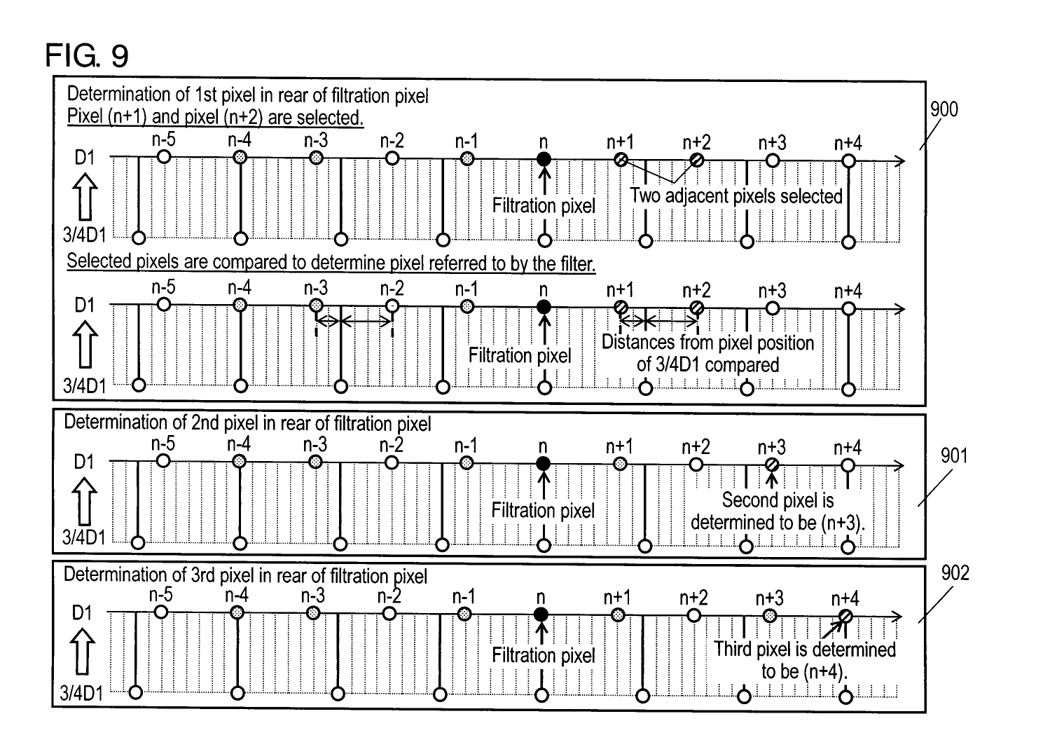

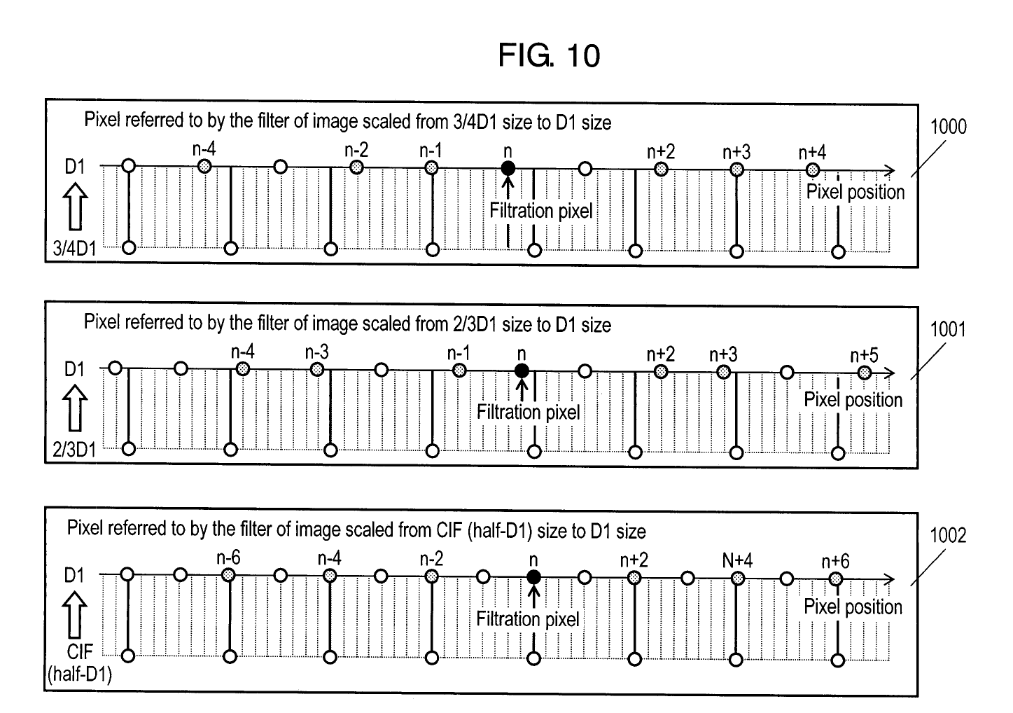

Regarding the filter reference pixel selecting method, the operation will be described with reference to FIG. 6, FIG. 7, FIG. 8, FIG. 9, and FIG. 10. FIG. 6 is a flow chart showing the filter reference pixel selecting method. The filter reference pixel is pixel referred to by the filter.

As an example, as to an image scaled from ¾D1 (H540×V480) size to D1 (H720×V480) size, a method of determining the filter reference pixel in 7-tap filtration with respect to n-th pixel will be described. When the filter reference pixel of 7-tap filter is selected, the filtration pixel is already determined, and therefore, it is necessary to select the other 6 pixels (3 pixels in front and 3 pixels in rear of filtration pixel).

Pixel positions of image scaled from ¾D1 size to D1 size 700 of FIG. 7 shows the pixel positions of image before and after scaling. The pixel interval of before-scaling image (¾D1) is divided into eight blocks, and the pixel position of after-scaling image (D1) is shown at the upper part of the block. When the image is scaled from ¾D1 (H540×V480) size to D1 (H720×V480) size, the pixel interval is multiplied by ¾ as the horizontal resolution is multiplied by 4/3, and the pixel positions are as shown in Pixel positions of image scaled from ¾D1 size to D1 size 700.

In step 600 shown in FIG. 6, two pixels (pixel n−1 and pixel n−2) closer to the filtration pixel are selected as in Determination of 1st pixel in front of filtration pixel 701 of FIG. 7, and the distances from the pixel position (nearest pixel) of before-scaling image (¾D1) to the selected two pixels are obtained, and the pixel closer to the pixel position of the before-scaling image is determined to be filter reference pixel. The distance from pixel n−1 to the pixel position of before-scaling image is two blocks, and the distance from pixel n−2 to the pixel position of before-scaling image is four blocks. Accordingly, pixel n−1 is the 1st pixel in front of filtration pixel.

In step 601, two pixels (pixel n−2 and pixel n−3) closer to the filter reference pixel (since pixel n−1 is determined to be the filter reference pixel in step 600, the filter reference pixel is pixel n−1) are selected as in Determination of 2nd pixel in front of filtration pixel 800 in FIG. 8, and the distances from the pixel position of before-scaling image to the selected two pixels are respectively obtained, then the pixel closer to the pixel position of before-scaling image is determined to be filter reference pixel. The distance from pixel n−2 to the pixel position of before-scaling image is four blocks, and the distance from pixel n−3 to the pixel position of before-scaling image is two blocks. Accordingly, pixel n−3 is the 2nd pixel in front of filtration pixel.

In step 602, two pixels (pixel n−4 and pixel n−5) closer to the filter reference pixel are selected as in Determination of 3rd pixel in front of filtration pixel 801 in FIG. 8, and the distances from the pixel position of before-scaling image to the selected two pixels are respectively obtained, then the pixel closer to the pixel position of before-scaling image is determined to be filter reference pixel. The distance from pixel n−4 to pixel position of before-scaling image is zero block, and the distance from pixel n−5 to the pixel position of before-scaling image is two blocks. Accordingly, pixel n−4 is the 3rd pixel in front of filtration pixel.

In step 603, two pixels (pixel n+1 and pixel n+2) closer to the filtration pixel are selected as in Determination of 1st pixel in rear of filtration pixel 900 in FIG. 9, and the distances from the pixel position of before-scaling image to the selected two pixels are respectively obtained, then the pixel closer to the pixel position of before-scaling image is determined to be filter reference pixel. The distance from pixel n+1 to the pixel position of before-scaling image is two blocks, and the distance from pixel n+2 to the pixel position of before-scaling image is four blocks. Accordingly, pixel n+1 is the first pixel in rear of filtration pixel.

In step 604, according to the same method as described above, pixel n+3 is the second pixel in rear of filtration pixel as shown in Determination of 2nd pixel in rear of filtration pixel 901 in FIG. 9.

Also in step 605, according to the same method so far described, pixel n+4 is the third pixel in rear of filtration pixel as shown in Determination of 3rd pixel in rear of filtration pixel 902 in FIG. 9.

The filter reference pixel of 7-tap filter is determined through the above procedure.

FIG. 10 shows an example of filter reference pixel selected when 7-tap filter processing is executed with respect to image scaled at various ratios.

Filter reference pixel of image scaled from ¾D1 size to D1 size 1000 is an example of image scaled from ¾D1 (H540×V480) size to D1 (H720×V480) size.

Filter reference pixel of image scaled from ⅔D1 size to D1 size 1001 is an example of image scaled from ⅔D1 (H480×V480) size to D1 (H720×V480) size.

Filter reference pixel of image scaled from CIF (half-D1) size to D1 size 1002 is an example of image scaled from CIF (H360×V480) size or half-D1 (H360×V480) to D1 (H720×V480) size.

### Preferred Embodiment 2

FIG. 1 is a block diagram describing filter unit 100 for NR processing. The determining unit shown in FIG. 1 has same configuration as in the preferred embodiment 1.

[Operation of Filter Unit 100]

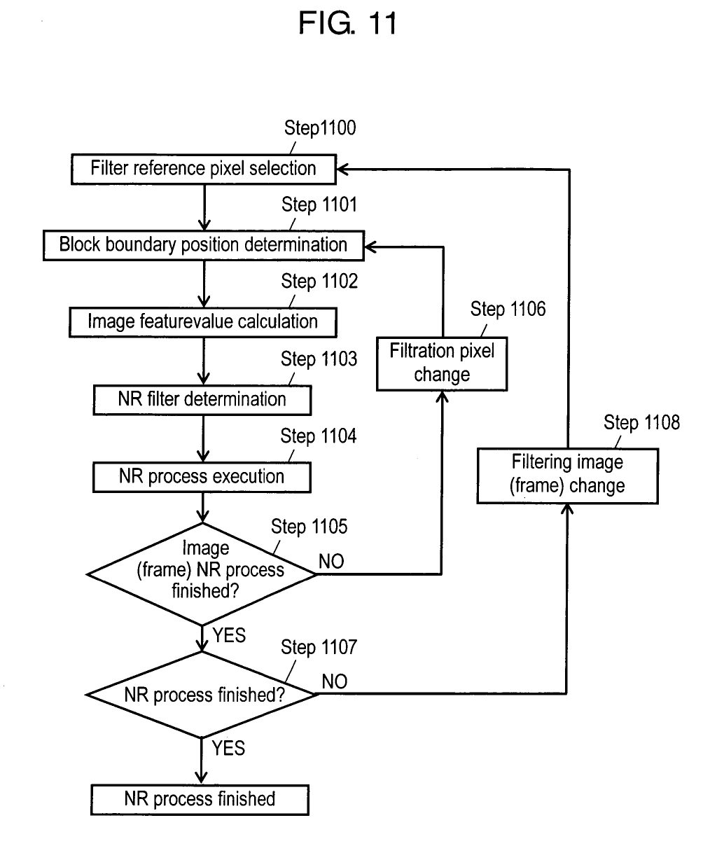

The operation of filter unit 100 will be described with reference to FIG. 11. FIG. 11 is a flow chart showing the NR processing method of the filter unit in the preferred embodiment 2. As an example, described here is a case such that filtration pixel n is subjected to NR filtering of 7 taps max.

In step 1100 shown in FIG. 11, filter reference pixels concerned are determined in filtering of filtration pixel. The filter reference pixels are pixels referred to by the filter. Filter reference pixels are selected as shown in Filtration pixel and reference pixel positions 300 in FIG. 3. In case the distance from filtration pixel n ranges from step [0] to step [6], then the filter reference pixels are determined to be 7 pixels ranging from n+step [0] to n+step [6]. (The method of selecting the filter reference pixels is described in detail later.) In the preferred embodiment 2, filter reference pixels in step 1100 are selected automatically or optionally in accordance with the image characteristics of input. When the filter reference pixel is changed, it can be executed when filtering image (frame) is changed without changing the filter reference pixel each time the filtration pixel is changed.

In step 1101, the determination of block boundary position is made the same as in step 201 in the preferred embodiment 1. When the block boundary exists within the range of filter reference pixel selected in step 1100, the position of filter reference pixel where block boundary exists is determined.

In step 1102, the same as in the preferred embodiment 1, because of the comparison with the threshold of image feature value set in each of the filters for determining the NR filter in step 1103, the image feature value is calculated from filtration pixel.

In step 1103, same as in step 203 in the preferred embodiment 1, in accordance with the position of filter reference pixel where the block boundary obtained in step 1101 exists and image feature values d [0] to d [5] obtained in step 1102, comparison is made with the threshold of image feature value set in each of the filters for determining the NR filter, and the filter applied in step 1104 is determined.

In step 1104, same as in step 204 in the preferred embodiment 1, NR filtration is executed by the filter selected in step 1103 in accordance with filter reference pixel selected in step 1100 with respect to filtration pixel n.

In step 1105, it is determined whether NR processing in same image (frame) is continued or filtering of the image (frame) to be filtered is finished. In case NR processing in same image (frame) is not completely finished, it goes to step 1106. In case filtering of the image (frame) to be filtered is finished, it goes to step 1107.

In step 1106, filtration pixel is changed. In the earlier NR processing, NR processing is executed with respect to pixel n, and therefore, it goes to step 1101 as the next pixel n+1 is the filtration pixel. Further, from step 1101, filter reference pixel is selected from filtration pixel n+1 (it is not through filter reference pixel selection in step 1100, and therefore, the pixel interval from filtration pixel to filter reference pixel, step [0] to step [6], is fixed), and same processing after step 1101 is executed.

In step 1107, it is determined whether NR processing is continued or finished. In case NR processing is continued, it goes to step 1108. In case NR processing is finished, the NR processing will be finished.

In step 1108, the image (frame) to be filtered is changed, and same processing after step 1100 is executed.

[Filter Reference Pixel Selecting Method]

In the preferred embodiment 2, filter reference pixel is freely selected out of several kinds of filter reference pixel structures previously determined, automatically according to the characteristic of input image or optionally for changing the filter characteristic.

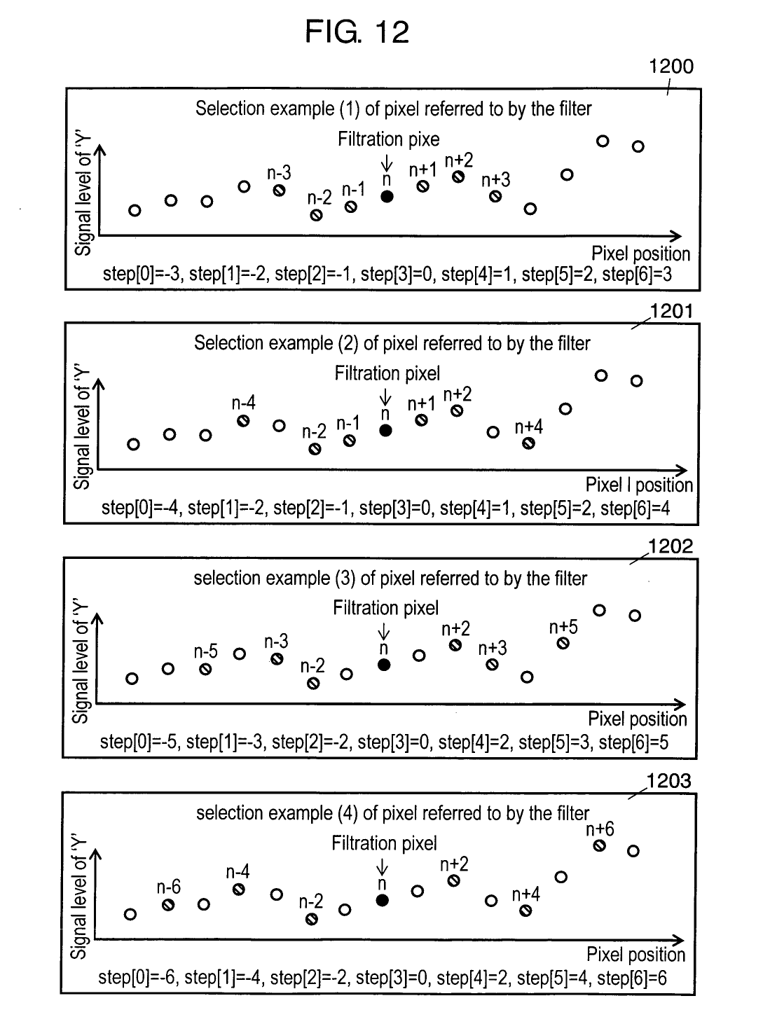

As an example, the filter reference pixel in 7-tap filtering with respect to n-th pixel will be described by using FIG. 12. The filter reference pixel is pixel referred to by the filter.

FIG. 12 shows a filter reference pixel selection example, the distance from filtration pixel to each filter reference pixel, step [0] to step [6], is previously determined, and setting in accordance with the characteristic of input image is automatically made or optionally made for changing the filter characteristic.

In the example of automatically making the setting in accordance with the characteristic of input image, filter reference pixel selection example (1) 1200 is applied when the DCT block size of input image is 8×8 (image not scaled), filter reference pixel selection example (2) 1201 is applied in the case of image scaled from ¾ D1 size to D1 size, filter reference pixel selection example (3) 1202 is applied when DCT block size is 12×12 (image scaled from ⅔ D1 size to D1 size), and filter reference pixel selection example (4) 1203 is applied when DCT block size is 16×16 (image scaled from CIF size to D1 size).

In the example of optionally making the setting for changing the filter characteristic, filter reference pixel selection example (4) 1203 of wider reference range is applied when the filter effect is expected to be higher, and filter reference pixel selection example (1) 1200 is applied when the filter effect is expected to be a little lower.

As is obvious in the above description, in the signal processing apparatus and signal processing method of the present invention, the filter reference pixels can be set in a wide range, which is useful for NR filtering of various sizes of images subjected to scaling or the like in accordance with the characteristic of each input image.

What is claimed is:

1. A signal processing apparatus, comprising:
a plurality of filters;
a determining unit for determining pixels referred to by the filters; and
a selecting unit for selecting one out of the plurality of filters in accordance with image feature values calculated by using pixels selected by the determining unit and thresholds of the image feature values set with respect to each of the plurality of filters.

2. The signal processing apparatus of claim 1, further comprising:
a memory for storing pixel data around a filtration pixel,
wherein the determining unit determines pixels referred to by the filter within a range of the memory.

3. The signal processing apparatus of claim 1,
wherein the determining unit determines pixels referred to by the filter in accordance with information of original image to be filtered.

4. The signal processing apparatus of claim 2,
wherein the determining unit determines pixels referred to by the filter in accordance with information of original image to be filtered.

5. The signal processing apparatus of claim 1,
wherein the determining unit determines pixels referred to by the filter in accordance with information of the original image and the filtration pixels.

6. The signal processing apparatus of claim 2,
wherein the determining unit determines pixels referred to by the filter in accordance with information of the original image and the filtration pixels.

7. The signal processing apparatus of claim 1,
wherein the determining unit determines pixels referred to by the filter so as to change the plurality of filters into desired characteristics.

8. The signal processing apparatus of claim 1,
wherein the image feature value is calculated by using at least two pixels referred to determined by the determining unit.

9. The signal processing apparatus of claim 1,
wherein the selecting unit selects the filter by using thresholds set for a block boundary when pixels used for calculating the image feature values are located across the block boundary.

10. A signal processing method, comprising:
a determining step for determining pixels referred to by a plurality of filters; and
a selecting step for selecting one out of the plurality of filters in accordance with image feature value calculated by using pixels selected in the determining step and thresholds of image feature value set with respect to each of the plurality of filters.

11. The signal processing method of claim 10,
wherein the determining step determines pixels referred to by the filter within a range of memory for storing pixel data around the filtration pixel.

12. The signal processing method of claim 10,
wherein the determining step determines pixels referred to by the filter in accordance with information of original image to be filtered.

13. The signal processing method of claim 11,
wherein the determining step determines pixels referred to by the filter in accordance with information of original image to be filtered.

14. The signal processing method of claim 10,
wherein the determining step determines pixels referred to by the filter in accordance with information of the original image and the filtration pixels.

15. The signal processing method of claim 11,
wherein the determining step determines pixels referred to by the filter in accordance with information of the original image and the filtration pixels.

16. The signal processing method of claim 10,
wherein the determining step determines pixels referred to by the filter so as to change the plurality of filters into desired characteristics.

17. The signal processing method of claim 10,
wherein the image feature value is calculated by using at least two pixels referred to determined in the determining step.

18. The signal processing method of claim 10,
wherein the selecting step selects the filters by using thresholds set for a block boundary when pixels used for calculating the image feature values are located across the block boundary.
